(19) United States
(12) Patent Application Publication
(10) Pub. No.: US 2026/0071587 A1
(43) Pub. Date: Mar. 12, 2026

(54) INTERNAL COMBUSTION ENGINE HAVING A TOP-DOWN COOLING CONCEPT

(71) Applicant: AVL LIST GMBH, Graz (AT)

(72) Inventors: Andreas Zurk, Weinburg (AT); Anton Arnberger, Lieboch (AT); Martin Klampfer, Hitzendorf (AT)

(21) Appl. No.: 19/101,815

(22) PCT Filed: Aug. 7, 2023
(86) PCT No.: PCT/AT2023/060262

§ 371 Date: Feb. 6, 2025

(30) Foreign Application Priority Data
Aug. 8, 2022 (AT) A 50596/2022

(51) Int. Cl. F02F 1/40; F02F 1/24; F02F 1/42

(52) U.S. Cl. CPC F02F 1/40; F02F 1/242; F02F 1/4235

(57) ABSTRACT

The invention relates to an internal combustion engine having a top-down cooling concept, in particular with a plurality of cylinders, having a liquid-cooled cylinder head with a first cooling chamber adjoining a fire deck and a second cooling chamber, which is separated from the first cooling chamber by an intermediate deck, and which is predominantly further away from the fire deck (10) than the first cooling chamber, wherein the first cooling chamber and the second cooling chamber are flow-connected to one another in the region of the ignition device, with an intake port arrangement on an intake side and an exhaust port arrangement on an exhaust side, having, per cylinder, two intake valves, two exhaust valves, an ignition device opening centrally into a combustion chamber and an injection device opening laterally into the combustion chamber, which is arranged between a first intake port and a second intake port of the intake port arrangement. In order to enable sufficient cooling of the injection device, the first intake port and the second intake port of each cylinder in the cylinder head are routed separately starting from at least one lateral flange surface of the cylinder head, and the injection device is at least partially surrounded by a cooling chamber, which is flow-connected to the second cooling chamber or is formed as part of the second cooling chamber.

The invention relates to an internal combustion engine having a top-down cooling concept, in particular with a plurality of cylinders, having a liquid-cooled cylinder head with a first cooling chamber adjoining a fire deck and a second cooling chamber which is separated from the first cooling chamber by an intermediate deck and which is predominantly further away from the fire deck than the first cooling chamber, wherein the first cooling chamber and the second cooling chamber are flow-connected to one another in the region of the ignition device, having an intake port arrangement on an intake side and an exhaust port arrangement on an exhaust side of the cylinder head, having, per cylinder, two intake valves, two exhaust valves, an ignition device opening centrally into a combustion chamber and an injection device opening laterally into the combustion chamber, which is arranged between a first intake port and a second intake port of the intake port arrangement.

A top-down cooling concept is a cooling concept in which the coolant first flows through the second cooling chamber, which is further away from the fire deck, and only then through the first cooling chamber, which is close to the fire deck.

An internal combustion engine of this type with two intake valves and two exhaust valves, a central ignition device and a lateral injection device is known from AT 524 316 B1. An intake port leads to each intake valve, wherein the intake ports within the cylinder head start from a common main intake port. A bore arrangement having several cooling bores is provided for cooling the injection device arranged between the two intake ports.

A single-cylinder internal combustion engine with a laterally arranged injector is known from U.S. Pat. No. 5,983,843 A, wherein a bore arrangement having a plurality of cooling bores is provided for cooling the injector, which are molded in from one end face. This bore arrangement is less suitable for internal combustion engines with more than two cylinders.

EP 1 443 188 A2 describes a reciprocating internal combustion engine with at least one combustion chamber with direct gasoline injection with a cylinder head which has two intake gas exchange valves, two exhaust gas exchange valves and an ignition device arranged between the gas exchange valves and a gasoline injection valve arranged between an intake gas exchange valve and an exhaust gas exchange valve, wherein the intake valve shafts and the exhaust valve shafts each span a plane which is aligned substantially parallel to a longitudinal axis of the internal combustion engine. The longitudinal axis of the gasoline injection valve is aligned parallel to the cylinder axis.

WO 2007/125400 A2 discloses a spark-ignition internal combustion engine with a centrally arranged ignition device and an injection device arranged eccentrically in the roof-shaped combustion chamber ceiling between two exhaust valves.

In internal combustion engines of the type mentioned at the beginning, there is sometimes too little free installation space available on the intake side in the region of the injection device to ensure sufficient cooling of the injection device.

It is the object of the invention to enable sufficient cooling of the injection device in an internal combustion engine of the type mentioned at the beginning in a simple manner.

According to the invention, this object is solved in an internal combustion engine of the type mentioned at the beginning in that the first intake port and the second intake port of each cylinder in the cylinder head are routed separately starting from at least one lateral flange surface of the cylinder head, and in that the injection device is at least partially surrounded by a cooling chamber which is flow-connected to the second cooling chamber or is formed as part of the second cooling chamber.

The fact that the first intake port and the second intake port of each cylinder in the cylinder head are routed separately starting from at least one lateral flange surface of the cylinder head ensures that sufficient installation space can be provided between the intake ports for the arrangement and cooling of the injection device. The cooling chamber surrounding at least the injection device enables sufficient cooling of the injection device.

In one embodiment variant of the invention, it is provided that the cooling chamber is connected to a cooling jacket of a cylinder block adjacent to the cylinder head via at least one connecting duct arranged in the firing deck on the intake side. This allows the injection device to be cooled directly with the coolant coming from the cylinder block.

Preferably, at least one first cylinder-head screw is arranged between the first intake port and the injection device and/or at least one second cylinder-head screw is arranged between the second intake port and the injection device. The intake ports are thus each routed between two cylinder-head screws, wherein the intake ports are routed in an arc around the cylinder-head screws adjacent to the intake device. This makes it possible to provide sufficient installation space for the arrangement of cooling ducts and cooling chambers for cooling the injection device.

In one embodiment variant of the invention, it is provided that at least two adjacent intake ports of two adjacent cylinders extend from a common flange surface. Advantageously, these at least two intake ports of adjacent cylinders are arranged directly on either side of a transverse engine plane extending between two adjacent cylinders. Thus, the first intake port and the second intake port of each cylinder are spaced as far apart as possible, wherein the maximum distance between the two intake ports corresponds approximately to the bore diameter of the cylinder.

At least one third cylinder-head screw can be arranged in the region of at least one transverse engine plane between two adjacent cylinders, wherein the third cylinder-head screw is preferably at a shorter distance from a longitudinal engine plane spanned by the cylinder axes than the first cylinder-head screw and/or the second cylinder-head screw.

One embodiment variant of the invention provides for the first cooling chamber to have at least one first cooling duct arranged between the first intake port and the injection device and at least one second cooling duct arranged between the second intake port and the injection device, with the first cooling duct and/or the second cooling duct preferably being cast. The first and second cooling ducts at least partially surround the injection device and extend from a third web duct, which runs close to the fire deck in the region of the intake valve seats between the two intake ports.

The intake valves and/or exhaust valves are preferably arranged-with a maximum deviation of ±5°—essentially parallel to the cylinder axis.

It is preferably provided that the distance between the orifice of the injection device and the cylinder axis is 35% to 45% of the bore diameter of the cylinder. This ensures that the fuel is optimally injected into the—preferably cylindrical—intake flow.

A pronounced tumble charge movement can be initiated in the combustion chamber if at least one of the intake ports-preferably both intake ports-is/are tumble-generating.

To support the tumble charge movement, it is also advantageous if at least one preferably asymmetrical chamfer is machined into the fire deck of the cylinder head on the side of at least one intake valve seat facing the exhaust side.

In order to initiate a symmetrical intake roller flow, it is advantageous if the first intake port and the second intake port of at least one cylinder are designed symmetrically with respect to a transverse engine plane containing the cylinder axis. Advantageously, the longitudinal axis of the injection device is arranged in a transverse engine plane containing the cylinder axis.

In a further embodiment of the invention, it is provided that at least one exhaust port adjoins the first cooling chamber and the second cooling chamber, wherein the second cooling chamber is arranged at least partially—preferably completely—on a side of the exhaust port facing away from the first cooling chamber.

Advantageously, the first cooling chamber is flow-connected to the second cooling chamber in the region of the ignition device via at least one connecting duct arranged on the outlet side and/or intake side, with the connecting duct preferably being a cast duct.

It is preferably provided that the first cooling chamber in the region of the ignition device is flow-connected to the second cooling chamber via at least one connecting duct, preferably arranged on the exhaust side, wherein the connecting duct is preferably a cast duct. The coolant enters the second cooling chamber directly from the cylinder block—preferably in the region of the injection device—and reaches the first cooling chamber close to the fire deck via the at least one connecting duct in the region of the ignition device.

In the context of the invention, it is further provided that an ignition device sleeve is arranged in the cylinder head to accommodate the ignition device, wherein the ignition device sleeve is preferably of wet design and directly adjoins the first cooling chamber and/or the second cooling chamber.

Furthermore, it is advantageous for good cooling of the injection device if an injector sleeve is arranged in the cylinder head to accommodate the injection device, wherein the injector sleeve is preferably of a wet design and directly adjoins the cooling chamber and/or the second cooling chamber.

The invention is explained in more detail below with reference to the non-limiting exemplary embodiment shown in the figures, wherein:

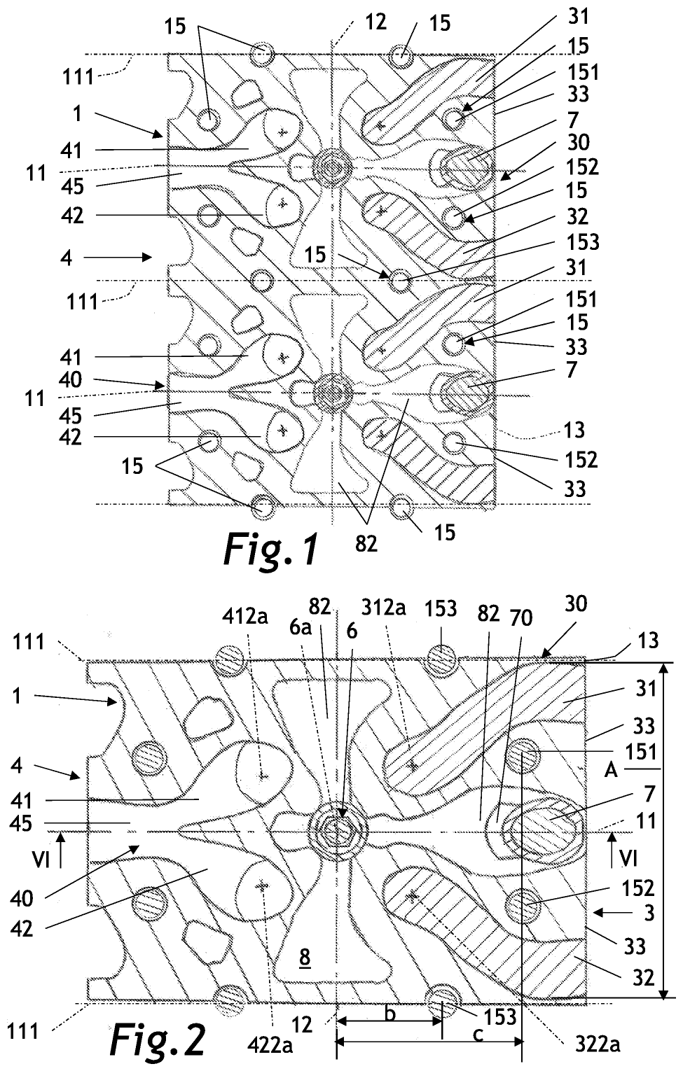

FIG. 1 shows a cylinder head of an internal combustion engine according to the invention in a sectional view along line I-I in FIG. 5;

FIG. 2 Shows a Detailed View of the Cylinder Head From FIG. 1;

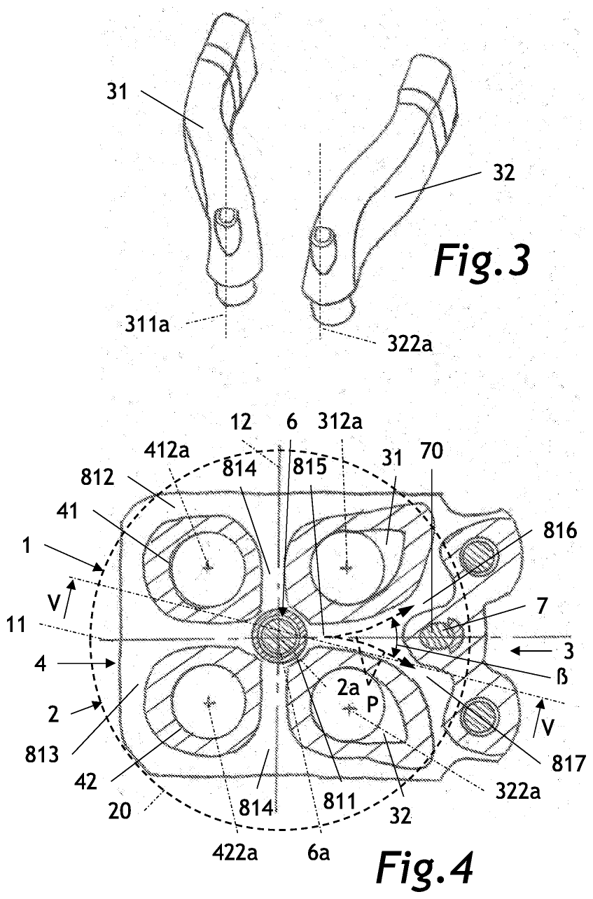

FIG. 3 shows the intake ports of the cylinder head in an axonometric core

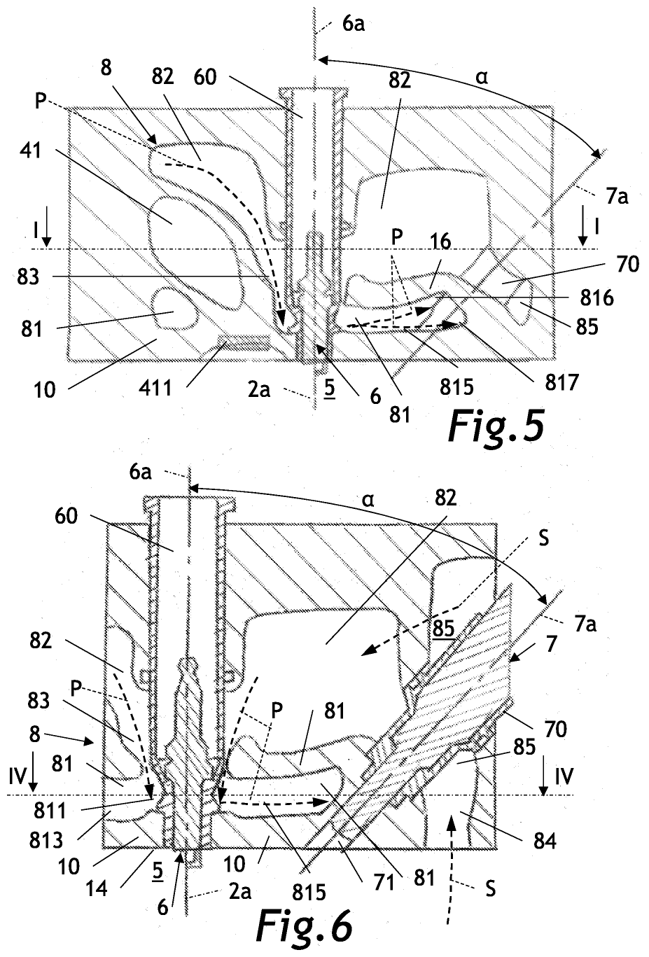

FIG. 4 shows the cylinder head in section according to line IV-IV in FIG. 6;

FIG. 5 shows the cylinder head in a section along the line V-V in FIG. 4;

FIG. 6 the cylinder head in a section according to line VI-VI in FIG. 2;

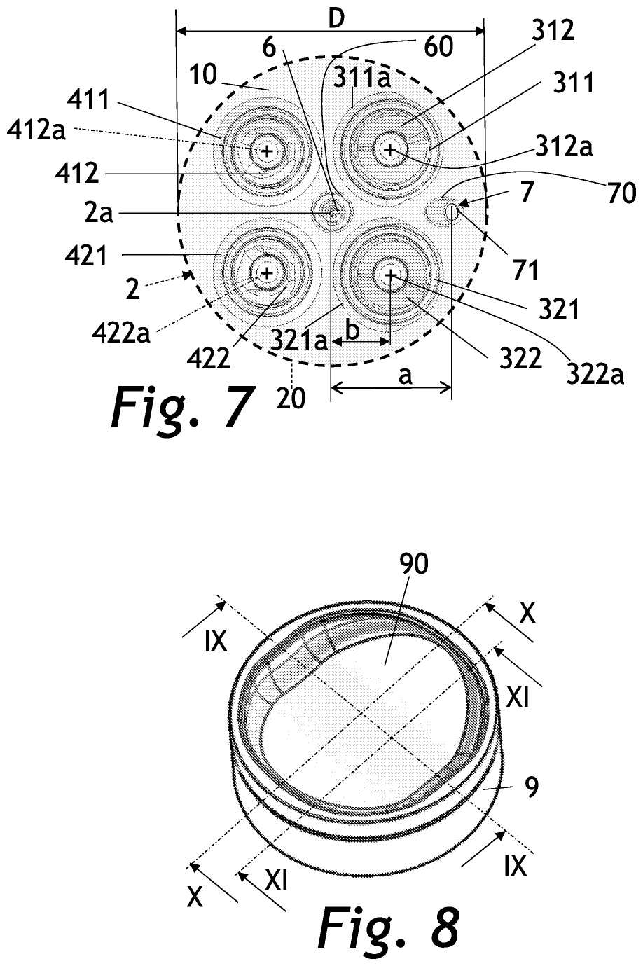

FIG. 7 shows a view of the cylinder head from the combustion chamber side;

FIG. 8 shows an axonometric representation of a piston recess of an internal combustion engine piston;

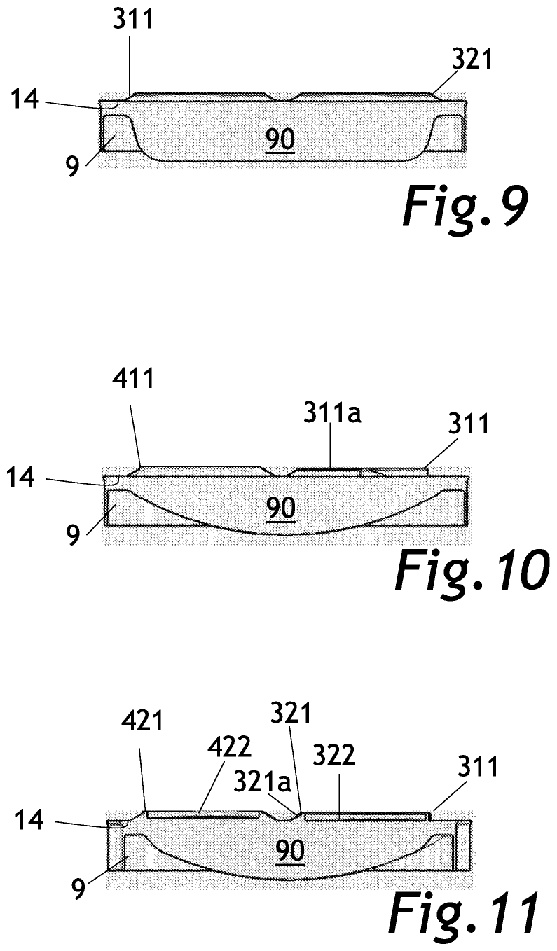

FIG. 9 shows the piston recess in a section along line IX-IX in FIG. 8;

FIG. 10 shows the piston recess in a section along the line X-X in FIG. 8; and

FIG. 11 shows the piston recess in a section along the line XI-XI in FIG. 8.

The cylinder head 1 of a multi-cylinder internal combustion engine shown in FIG. 1 to FIG. 7 has an intake port arrangement 30 arranged on an intake side 3 and an exhaust port arrangement 40 arranged on an exhaust side 4 for each cylinder 2. The intake-side longitudinal side wall 13 of the cylinder head 1 runs in the longitudinal direction of the internal combustion engine and is oriented parallel to the longitudinal engine plane 12, for example. The tumble-generating intake port arrangement 30 has a first intake port 31 with a first intake valve seat 311 for a first intake valve 312 and a second intake port 32 with a second intake valve seat 321 for a second intake valve 322. The two intake ports 31, 32 extend from the intake side 3 of the cylinder head 1 and are each guided completely separately between a flange surface 33 on the intake side 3 and the intake valve seats 311, 312 (FIG. 2, FIG. 7).

In the cylinder head 1 shown, eight cylinder-head screws 15 are assigned to at least one cylinder 2, which-viewed in plan-can be arranged in the shape of a regular octagon, for example, and have the same radial distance from the cylinder axis 2a. The cylinder-head screws 15 arranged in the region of the transverse engine plane 111 between two adjacent cylinders 2 are assigned to both adjacent cylinders 2.

At least one first cylinder-head screw 151 is arranged between the first intake port 31 and the injection device 7, and at least one second cylinder-head screw 152 is arranged between the second intake port 32 and the injection device 7. In the region of a transverse engine plane 111 between two cylinders 2, at least one third cylinder-head screw 153 is arranged between two adjacent intake ports 31, 32, each belonging to different cylinders 2. The third cylinder-head screw 153 has a smaller distance b from a longitudinal engine plane 12 spanned by the cylinder axes 2a than the first cylinder-head screw 151 or the second cylinder-head screw 152, whose distances from the longitudinal engine plane are each designated by c (FIG. 2).

The intake ports 31, 32 are thus each routed between two cylinder-head screws 151, 152, with the intake ports 31, 32 being routed in an arc around the cylinder-head screws 151, 152 adjacent to the intake device 7. This makes it possible to provide sufficient installation space for the arrangement of cooling ducts and cooling chambers for cooling the injection device 7.

The intake ports 31, 32 are designed to generate a cylindrical charge movement in the combustion chamber 5. The valve axes of the first intake valve 312 and the second intake valve 322 are designated by reference signs 312a, 322a (FIG. 2, FIG. 3, FIG. 7).

In at least one cylinder 2, the first intake port 31 and the second intake port 32 are arranged at the greatest possible distance from one another, wherein, for example, the maximum distance A between the two intake ports 31, 32 corresponds approximately to the bore diameter D of the cylinder 2 (FIG. 2).

The exhaust port arrangement 40 has a first exhaust port 41 with a first exhaust valve seat 411 for a first exhaust valve 412 and a second exhaust port 42 with a second exhaust valve seat 421 for a second exhaust valve 422. The two exhaust ports 41, 42 open into a common main exhaust port 45 per cylinder 2. The valve axes of the first exhaust valve 412 and the second exhaust valve 422 are indicated by reference signs 412a, 422a (FIG. 2, FIG. 7).

An ignition device 6 opening into the combustion chamber 5 is arranged centrally in the region of the cylinder axis 2a of the cylinder 2, wherein the ignition device 6 is accommodated by an ignition device sleeve 60 arranged in the cylinder head 1. The eccentricity of the longitudinal axis 6a of the ignition device 6 to the cylinder axis 2a is a maximum of 2-3 mm or a maximum of 2% of the bore diameter D (FIG. 7).

An injection device 7 for direct fuel injection into the combustion chamber 5 is arranged between the two intake ports 31, 32 at a first distance a from the cylinder axis 2a, wherein the first distance a between the orifice 71 of the injection device 7 and the cylinder axis 2a is approximately 35% to 45% of the bore diameter D of the cylinder 2. The first distance a is greater here than the second distance b measured between the valve axis 312a, 322a of the intake valve 312, 322 and the cylinder axis 2a. In the exemplary embodiment, the injection device 7 is arranged in an injector sleeve 70 that is firmly connected to the cylinder head 1 (FIG. 7). Alternatively, the injection device 7 can also be arranged directly—i.e. without injector sleeve 70—in the cylinder head 1.

The combustion chamber ceiling 14 of the cylinder head 1 formed by the combustion deck 10 is essentially flat, in particular plane, and normal to the cylinder axis 2a, i.e. not “roof-shaped”. The valve axes 312a, 322a; 412a, 422a of the intake valves 312, 322 and the exhaust valves 412, 422 are inclined with respect to the cylinder axis 2a by an angle of at most 5° and preferably parallel to the cylinder axis 2a. The longitudinal axis 7a of the injection device 7 is inclined by a first angle a of 45° with respect to the cylinder axis 2a.

The liquid-cooled cylinder head 1 has a cooling chamber arrangement 8 designed in particular for top-down cooling concepts with a first cooling chamber 81 and a second cooling chamber 82, wherein the second cooling chamber 82 is arranged above the first cooling chamber 81, remote from the fire deck. An intermediate deck 16 of the cylinder head is formed between the first cooling chamber 81 and the second cooling chamber 82, which separates the two cooling chambers 81, 82 from one another. The first cooling chamber 81 is arranged below the exhaust ports 41, 42 adjacent to the fire deck 10, i.e. between the exhaust ports 41, 42 and the fire deck 10. The first cooling chamber 81 has an inner annular duct 811 formed circumferentially around the ignition device 6 between the ignition device 6 and intake ports 31, 32 and exhaust ports 41, 42 and an outer annular duct 812 formed circumferentially in the region of the cylinder edge 20 (FIG. 4). In top-down cooling concepts, the coolant first flows through the second cooling chamber 82 further away from the fire deck and only then through the first cooling chamber 81 close to the fire deck.

On the exhaust side 4, the inner annular duct 811 is flow-connected to the outer annular duct 812 via a cast first web duct 813, which is arranged between the exhaust valve seats 411, 421 of the exhaust valves 412, 422 in the region of a transverse engine plane 11 extending through the cylinder axis 2a. Furthermore, the inner annular duct 811 is flow-connected to the outer annular duct 812 in the region of a longitudinal engine plane 12 containing the cylinder axis 2a via cast second web ducts 814, wherein the second web ducts 814 are each arranged between an exhaust valve seat 411, 421 and an intake valve seat 311, 321. Furthermore, a third web duct 815 is arranged between the intake valve seats 311, 321 in the region of the transverse engine plane 11, which is divided into a first cooling duct 816 and a second cooling duct 817 and connects the inner annular duct 811 to the outer annular duct 812 via these cooling ducts 816, 817. The cooling ducts 816, 817 surround the injection device 7 on both sides of the transverse engine plane 11 and serve in particular to cool the area of the orifice 71 of the injection device 7.

The third web duct 815 and the cooling ducts 816, 817 are produced by casting and extend substantially radially with respect to the cylinder axis 2a in a normal plane to the cylinder axis 2a, wherein the first cooling duct 816 is arranged between the first intake port 31 and the injection device 7 and the second cooling duct 817 is arranged between the second intake port 32 and the injection device 7. The cooling ducts 816, 817 each run approximately centrally between the intake ports 31, 32 and the injection device 7 and are therefore approximately equidistant from the intake ports 31, 32 and the injection device 7 (FIG. 4).

Viewed in plan, the first cooling duct 816 and the second cooling duct 817 span an angle ß between approximately 20° and 45°, preferably approximately 30°±5°. The first cooling duct 816 and the second cooling duct 817 are arranged symmetrically to the transverse engine plane 11 containing the cylinder axis 2a and the longitudinal axis 7a of the injection device 7 (FIG. 4).

Above the exhaust ports 41, 42—i.e. on the side of the exhaust ports 41, 42 facing away from the first cooling chamber 81—the second cooling chamber 82 is arranged, which is flow-connected to the inner annular duct 811 of the first cooling chamber 81 via a cast connecting duct 83 in the region of the ignition device 6. The main cooling water transfer between the upper second cooling chamber 82 and the lower first cooling chamber 81 takes place via the connecting duct 83 arranged, for example, on the exhaust side 4. The ignition device sleeve 60 directly adjoins the first cooling chamber 81, the connecting duct 83 and the second cooling chamber 82, as can be seen in FIG. 6. The connecting duct 83 forms the main cooling water transfer between the second cooling chamber 82 and the first cooling chamber 81. The cooling water flows from the second cooling chamber 82 via the connecting duct 83 into the inner annular duct 811 of the first cooling chamber 81 and from this inner annular duct 811 via the first web duct 813, the second web ducts 814 in the longitudinal engine plane 12 and the third web duct 815 on the intake side through the cooling ducts 816, 817 on both sides of the injection device 7 into the outer annular duct 812 of the first cooling chamber 81, as indicated by arrows P in FIG. 5 and FIG. 6.

Optionally, a coolant supply directly from a cylinder block, which is not shown further and is connected to the cylinder head 1, can also be used to cool the injection device 7. As indicated by the arrows S in FIG. 6, the coolant flows from the cooling jacket of the cylinder block via a connecting duct 84 provided on the intake side 3 in the firing deck into a cooling chamber 85 at least partially surrounding the injector sleeve and reaches the second injector via at least one overflow channel not shown in FIG. 6. The second cooling chamber 82 and the first cooling chamber 81 are then flowed through using the top-down cooling method already described and the injection device 7 is cooled via the cooling ducts 816, 817 branching off from the third web duct.

The cylinder head 1 is particularly suitable for combustion processes using hydrogen, ethanol or methane as fuel The arrangement and orientation of the ignition device 6 and the injection device 7 with the intake valves 312, 322 and exhaust valves 412, 422 arranged “vertically”—i.e. parallel to the cylinder axis 2a—enable the implementation of a tumble combustion process. The generation of the tumble charge movement is supported by a suitable geometry of the intake port arrangement 30 and an asymmetrical machining of the intake valve seats 311, 321, wherein an asymmetrical or one-sided chamfer 311a, 321a (see FIG. 7) is machined into the fire deck 10 of the cylinder head 1 on the side of each intake valve seat 311, 321 facing the exhaust side 4 in order to direct the flow from the intake side 3 to the exhaust side 4. As shown in FIG. 2 and FIG. 3, the intake ports 31, 32 are formed in an arc and/or inclined with respect to the cylinder axis 2a in such a way that a tumble charge movement directed towards the ignition location of the ignition device 6 is generated in the combustion chamber 5.

The tumble charge movement in the combustion chamber 5 is additionally supported by pistons 9 with piston recesses 90, which have a so-called “pent roof shape”. This piston recess 90 shown in FIG. 8 to FIG. 11 leads to a timely decay of the tumble flow and conversion into turbulence before reaching the ignition location of the ignition device 6. This creates an optimum turbulence field around the centrally arranged ignition device 6.

1. An internal combustion engine having a top-down cooling concept, in particular with a plurality of cylinders, having a liquid-cooled cylinder head with a first cooling chamber adjoining a fire deck and a second cooling chamber which is separated from the first cooling chamber by an intermediate deck and which is predominantly further away from the fire deck than the first cooling chamber, wherein the first cooling chamber and the second cooling chamber are flow-connected to one another in the region of the ignition device, having an intake port arrangement on an intake side and an exhaust port arrangement on an exhaust side of the cylinder head, having, per cylinder, two intake valves, two exhaust valves, an ignition device opening centrally into a combustion chamber, and an injection device opening laterally into the combustion chamber, which is arranged between a first intake port and a second intake port of the intake port arrangement, wherein:
the first intake port and the second intake port of each cylinder in the cylinder head are routed separately starting from at least one lateral flange surface of the cylinder head, and
the injection device is at least partially surrounded by a cooling chamber which is flow-connected to the second cooling chamber or is formed as part of the second cooling chamber.

2. The internal combustion engine according to claim 1, wherein the cooling chamber is connected to a cooling jacket of a cylinder block adjacent to the cylinder head via at least one connecting duct arranged in the firing deck on the intake side.

3. The internal combustion engine according to claim 1, wherein at least one first cylinder-head screw is arranged between the first intake port and the injection device.

4. The internal combustion engine according to claim 1 wherein at least one second cylinder-head screw is arranged between the second intake port and the injection device.

5. The internal combustion engine according to claim 1 wherein at least two adjacent intake ports of two adjacent cylinders extend from a common flange surface.

6. The internal combustion engine according to claim 1 wherein at least two adjacent intake ports of adjacent cylinders are arranged directly on either side of a transverse engine plane extending between two adjacent cylinders.

7. The internal combustion engine according to claim 1, wherein in at least one cylinder, the first intake port and the second intake port are spaced apart as far as possible, and wherein a maximum distance between the two intake ports preferably corresponds to the bore diameter of the cylinder.

8. The internal combustion engine according to claim 1, wherein at least one third cylinder-head screw is arranged in the region of at least one transverse engine plane between two adjacent cylinders, wherein the third cylinder-head screw is at a shorter distance from a longitudinal engine plane spanned by the cylinder axes than the first cylinder-head screw and/or the second cylinder-head screw.

9. The internal combustion engine according to claim 1, wherein the first cooling chamber has at least one first cooling duct arranged between the first intake port and the injection device and at least one second cooling duct arranged between the second intake port and the injection device, wherein the first cooling duct and/or the second cooling duct is preferably cast and at least partially surrounds the injection device.

10. The internal combustion engine according to claim 1, wherein the intake valves and/or exhaust valves are arranged-with a maximum deviation of ±5°—parallel to the cylinder axis.

11. The internal combustion engine according to claim 1, wherein the injection device opens into a combustion chamber at an angle of approximately 45°±15° to the cylinder axis.

12. The internal combustion engine according to claim 1, wherein a distance (a) between the orifice of the injection device and the cylinder axis is 35% to 45% of a bore diameter of the cylinder.

13. The internal combustion engine according to claim 1, wherein at least one intake port is configured to generate tumble.

14. The internal combustion engine according to claim 1, wherein at least one asymmetrical chamfer is machined into the fire deck of the cylinder head on the side of at least one intake valve seat facing the exhaust side.

15. The internal combustion engine according to claim 1, wherein the first intake port and the second intake port of at least one cylinder are designed symmetrically with respect to at least one transverse engine plane.

16. The internal combustion engine according to claim 1, wherein the longitudinal axis of the injection device is arranged in a transverse engine plane containing the cylinder axis.

17. The internal combustion engine according to claim 1, wherein at least one exhaust port adjoins the first cooling chamber and the second cooling chamber, wherein the second cooling chamber is arranged on a side of the exhaust port facing away from the first cooling chamber.

18. The internal combustion engine according to claim 1, wherein the first cooling chamber in the region of the ignition device is flow-connected to the second cooling chamber via at least one connecting duct arranged on the exhaust side and/or the intake side, wherein the connecting duct is a cast duct.

19. The internal combustion engine according to claim 1, wherein an ignition device sleeve is arranged in the cylinder head to accommodate the ignition device, wherein the ignition device sleeve is of wet design and directly adjoins the first cooling chamber and/or the second cooling chamber.

20. The internal combustion engine according to claim 1, wherein an injector sleeve for receiving the injection device is arranged in the cylinder head, the injector sleeve being of wet design and directly adjoining the cooling chamber and/or the second cooling chamber.
